(19) United States
(12) Patent Application Publication
(10) Pub. No.: US 2014/0219080 A1
(43) Pub. Date: Aug. 7, 2014

(54) METHOD AND APPARATUS FOR INTERWORKING PROTECTION SWITCHING

(71) Applicant: Electronics and Telecommunications Research Institute, Daejeon (KR)

(72) Inventors: Daeub KIM, Daejeon (KR); Taesik CHEUNG, Daejeon (KR); Jeong-dong RYOO, Daejeon (KR)

(73) Assignee: Electronics and Telecommunications Research Institute, Daejeon (KR)

(21) Appl. No.: 14/168,079

(22) Filed: Jan. 30, 2014

(30) Foreign Application Priority Data
Feb. 1, 2013 (KR) 10-2013-0011890
Jan. 24, 2014 (KR) 10-2014-0008938

(51) Int. Cl. H04L 12/24

(52) U.S. Cl. CPC H04L 41/0668
USPC 370/221

(57) ABSTRACT

In a multi-domain network in which at least one working interconnected node and at least one protection interconnected node are formed between a first service end node and a second service end node, when a failure has occurred in both a working transport entity and a first protection transport entity of a node, a node having recognized a failure performs switching to a second protection transport entity that is connected to a corresponding interconnected node.

### CROSS-REFERENCE TO RELATED APPLICATION

This application claims priority to and the benefit of Korean Patent Application No. 10-2013-0011890 and No. 10-2014-0008938 filed in the Korean Intellectual Property Office on Feb. 1, 2013 and Jan. 24, 2014, the entire contents of which are incorporated herein by reference.

### BACKGROUND OF THE INVENTION

(a) Field of the Invention

The present invention relates to an interworking protection switching method and apparatus.

(b) Description of the Related Art

Protection switching is a method of starting traffic again as soon as possible when traffic has stopped as a failure occurs in a network. A protection switching method is divided into linear protection switching, ring protection switching, and sharing mesh protection switching according to a topology of a network, and linear protection switching includes various protection architectures such as 1+1, 1 to 1, 1 to N, and M to N.

Protection switching generally divides transport entities between nodes into a working transport entity (it may also be referred to as “a working path”) and a protection transport entity (it may also be referred to as “a protection path”), and when a failure does not exist, while carrying traffic to the working transport entity, if a failure occurs on a network or if a transport entity is changed according to the control of an operator, traffic is carried through the protection transport entity.

In circuit transport network technology such as an optical transport network (OTN) and packet transfer network technology such as Ethernet and multi-protocol label switching-transport profile (MPLS-TP), for linear protection switching, switching state management and transport entity protection switching is performed using an automatic protection switching (APS) message or a protection state coordination (PSC) message.

In a protected domain/segment network, upon performing end-to-end linear protection switching for a failure of a path (e.g., a transport entity) between two end nodes, a protection switching process (PSP) determines a bridge/selector of a transport entity.

However, when a node having a protection switching processor is damaged or when a failure occurs in both of two transport entities, protection restoration work cannot be performed.

### SUMMARY OF THE INVENTION

The present invention has been made in an effort to provide an interworking protection switching method and apparatus having advantages of being capable of performing protection restoration work when a failure occurs in a multi-domain network or a multi-segment network.

An exemplary embodiment of the present invention provides a method of performing protection switching in a multi-domain network or a multi-segment network in which at least one interconnected node is formed between nodes of a protection domain, the method including: performing switching to an added replacing transport entity or protection transport entity, when at least two failures have occurred within a protection domain.

The performing of switching may include, when at least two failures have occurred, as a failure has occurred in both a working transport entity and a first protection transport entity of a node, performing, by a node having recognized the failures, switching to a corresponding second protection transport entity, and the second protection transport entity comprises a transport entity connected to an interworking node that enables traffic between domains to be transmitted/received by avoiding an occurred failure.

Each node may use an interconnected node that performs traffic protection switching through a working transport entity and a first protection transport entity and another interconnected node that is used for transmitting and receiving traffic to and from an adjacent domain through a second protection transport entity for at least two failures.

A service end node may communicate with an working interconnected node corresponding to an adjacent node through a working transport entity and a first protection transport entity and communicates with a protection interconnected node corresponding to an adjacent node through a second protection transport entity, the working interconnected node may communicate with an end node or an working interconnected node corresponding to an adjacent node through a working transport entity and a first protection transport entity and communicates with a protection interconnected node or an end node corresponding to an adjacent node through a second protection transport entity, and each interconnected node may communicate with another protection interconnected node corresponding to an adjacent domain through a third protection transport entity.

The performing of switching to a second protection transport entity may include performing, by the node having recognized a failure, switching to a second protection transport entity that is connected to the protection interconnected node, when it is recognized that a failure has occurred in both a working transport entity and a first protection transport entity corresponding to the working interconnected node in which the failure has occurred, as a failure occurs in the working interconnected node.

The node, having recognized a failure, in the multi-domain network, may be at least one of two service end nodes and several interconnected nodes and other working interconnected nodes that is able to transmit/receive traffic to and from a corresponding adjacent domain by recognizing that a failure has occurred in two or more nodes in at least one domain.

The performing of switching to a second protection transport entity may include: notifying, by the working interconnected node, a corresponding node in its domain or a node corresponding to an adjacent domain that a failure has occurred, when a failure has occurred in both the working transport entity and the first protection transport entity that are connected to a domain that is managed in the working interconnected node and the first service end node; performing, by the node, having received notification that the failure has occurred, switching to the second protection transport entity that is connected to the protection interconnected node; and performing, by the first service end node, switching to the second protection transport entity that is connected to the protection interconnected node.

The performing of switching to a second protection transport entity may include: when a failure has occurred in both the working transport entity and the first protection transport entity that are connected to a domain that is managed in the working interconnected node and the first service end node and when a failure has occurred in the first protection transport entity with a node of an adjacent domain corresponding to the working interconnected node, performing, by the first service end node, switching to the second protection transport entity of a corresponding protection interconnected node; transmitting, by the first service end node, a message notifying that the failure has occurred through the second protection transport entity of the protection interconnected node; notifying, by the protection interconnected node having received the message, a node corresponding to an adjacent domain that the failure has occurred; and performing, by the node having received notification that the failure has occurred, switching to the second protection transport entity that is connected to the protection interconnected node.

When the node having received notification that a failure has occurred, is the second service end node, the second service end node may perform switching to the second protection transport entity that is connected to the protection interconnected node, and traffic from the first service end node may be transferred to the second service end node through the second protection transport entity that is connected to the protection interconnected node.

When the node, having received notification that the failure has occurred is another working interconnected node corresponding to an adjacent domain, traffic from the first service end node may be transferred to the second service end node through the second protection transport entity that is connected to the protection interconnected node, a second protection transport entity between the protection interconnected node and another working interconnected node corresponding to the adjacent domain, and a first working transport entity between the second service end node and another working interconnected node corresponding to the adjacent domain.

The performing of switching to a second protection transport entity may include: when a failure has occurred in both a working transport entity and a first protection transport entity that are connected to a domain that is managed in a service end node and the working interconnected node and when a failure has occurred in a working transport entity and a first protection transport entity related to a node of an adjacent domain corresponding to the working interconnected node, notifying, by the working interconnected node, that the failure has occurred through a second protection transport entity of a protection interconnected node corresponding to an adjacent domain; performing, by the protection interconnected node, having received notification that a failure has occurred, switching to a third protection transport entity that is connected to another protection interconnected node corresponding to an adjacent domain; and performing, by each node, switching to a second protection transport entity of a corresponding protection interconnected node.

The performing of switching to a second protection transport entity may include: when a failure has occurred in both a working transport entity and a first protection transport entity that are connected to a domain that is managed in a service end node and a working interconnected node, receiving, by the working interconnected node, notification that the failure has occurred through a second protection transport entity of another working interconnected node corresponding to an adjacent domain; notifying, by the working interconnected node, having received notification that the failure has occurred, that the failure has occurred through a second protection transport entity of a protection interconnected node corresponding to an adjacent domain; switching, by the protection interconnected node, having received notification that the failure has occurred, to a third protection transport entity that is connected to another protection interconnected node corresponding to an adjacent domain; switching to a third protection transport entity that is connected to a protection interconnected node corresponding to an adjacent domain; and switching, by each node, to a second protection transport entity of a corresponding protection interconnected node.

Traffic from the first service end node may be transferred to the second service end node through a second protection transport entity that is connected to the protection interconnected node, a third protection transport entity between the protection interconnected nodes, and a second protection transport entity between the protection interconnected node and the second service end node.

The performing of switching to a second protection transport entity may include: when a failure has occurred in both a working transport entity and a first protection transport entity between the first service end node and the working interconnected node and when the occurred failure is a one direction failure, notifying, by the working interconnected node, that the failure has occurred through a first protection transport entity of the second service end node or another working interconnected node of an adjacent domain; performing, by the node having received notification that the failure has occurred, switching to a second protection transport entity of a corresponding protection interconnected node; and performing, by the first service end node, switching to a second protection transport entity of a corresponding protection interconnected node.

The performing of switching to a second protection transport entity may include: when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node, notifying, by the working interconnected node, the protection interconnected node that the failure has occurred through a protection transport entity that is additionally formed between corresponding protection interconnected nodes; notifying, by the protection interconnected node, to the first service end node and the second service end node that a failure has occurred through a second protection transport entity; performing, by the first service end node, switching to a second protection transport entity of the protection interconnected node; and performing, by the second service end node, switching to a second protection transport entity of the protection interconnected node.

The additionally formed protection transport entity may be a tandem connection.

The performing of switching to a second protection transport entity may include: when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node, notifying, by the working interconnected node, that the failure has occurred by transmitting an additional operations, administration, and maintenance (OAM) message to the first service end node; and performing, by the first service end node, switching to a second protection transport entity of a corresponding protection interconnected node.

The method may further include: notifying, by the first service end node, that a failure has occurred through a second protection transport entity of the protection interconnected node; notifying, by the protection interconnected node, the second service end node that a failure has occurred through the second protection transport entity; and performing, by the second service end node, switching to the second protection transport entity of the protection interconnected node.

The performing of switching to a second protection transport entity may include, when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node, notifying, by the working interconnected node, that a failure has occurred by transmitting an automatic protection switching (APS) or protection state coordination (PSC) message to a node corresponding to the adjacent domain through a working transport entity according to an additional APS option.

Another embodiment of the present invention provides an interworking protection switching apparatus for performing protection switching in a multi-domain network or a multi-segment network in which at least one interconnected node is formed between nodes of a protected domain, the interworking protection switching apparatus including: an interworking protection switching processor for performing switching a transport entity in which there is no failure among protection transport entities when a plurality of failures have occurred within a protection domain.

The interworking protection switching processor may include a one stage protection switching processor that performs switching to a protection transport entity, when a failure has occurred within a protection domain; and a two stage protection switching processor that performs switching to an added replacing transport entity or protection transport entity, when at least two failures have occurred within a protection domain.

The two stage protection switching processor, when at least two failures have occurred, as a failure has occurred in both a working transport entity and a first protection transport entity of a node, may perform switching to a corresponding second protection transport entity, and the second protection transport entity comprises a transport entity connected to an interworking node that enables traffic between domains to be transmitted/received by avoiding an occurred failure.

The one stage protection switching processor and the two stage protection switching processor may be connected through a virtual working transport entity.

The each node may communicate with an working interconnected node through the working transport entity and the first protection transport entity and communicate with a protection interconnected node through the second protection transport entity, each working interconnected node may communicate with an working interconnected node corresponding to an adjacent domain through the working transport entity and the first protection transport entity and communicate with a protection interconnected node corresponding to an adjacent domain through the second protection transport entity, and each protection interconnected node may communicate with another protection interconnected node corresponding to an adjacent domain through a third protection transport entity.

### BRIEF DESCRIPTION OF THE DRAWINGS

FIGS. 1 and 2 are diagrams illustrating an interworking protection switching apparatus that performs a protection switching processing when a failure has occurred in a multi-domain network according to an exemplary embodiment of the present invention.

FIGS. 3 to 8 are diagrams illustrating a structure for protection switching in a multi-domain network based on an interworking protection switching apparatus according to an exemplary embodiment of the present invention.

FIGS. 9 to 12 are diagrams illustrating an example of a protection switching processing when a failure has occurred in a multi-domain network according to an exemplary embodiment of the present invention.

FIGS. 13 to 16 are diagrams illustrating another example of protection switching processing when a failure has occurred in a multi-domain network according to an exemplary embodiment of the present invention.

FIGS. 17 to 24 are diagrams illustrating another example of protection switching processing when a failure has occurred in a multi-domain network according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in an entire specification, unless explicitly described to the contrary, the word “comprise” and variations such as “comprises” or “comprising” will be understood to imply the inclusion of stated elements but not the exclusion of any other elements.

Hereinafter, an interworking protection switching method and apparatus according to an exemplary embodiment of the present invention will be described.

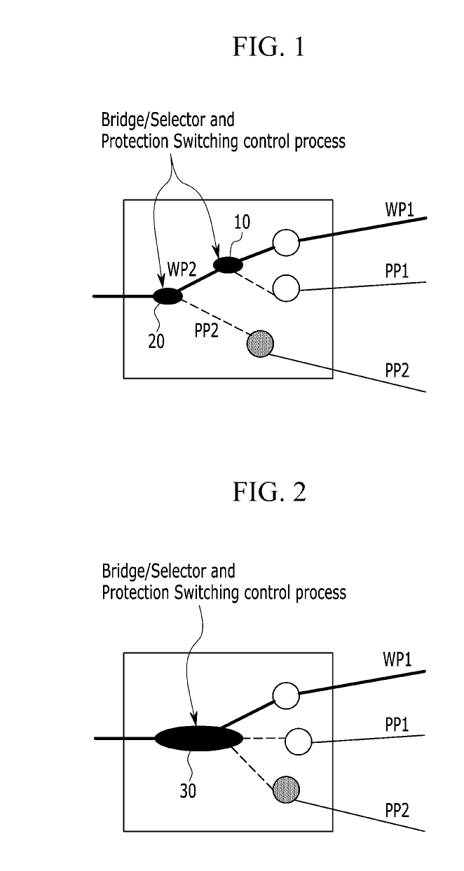

FIGS. 1 and 2 are diagrams illustrating an interworking protection switching apparatus that performs protection switching processing when a failure has occurred in a multi-domain network according to an exemplary embodiment of the present invention.

As shown in FIGS. 1 and 2, at least one protection transport entity (it may also be referred to as “a protection path”) PP1 and PP2 and a working transport entity (it may also be referred to as “a working path”) WP1 for transmitting/receiving a packet between a node and a node may be operated.

In a multi-domain network that is formed in such a structure, as a failure has occurred in transport entities and a connected node for transmitting/receiving a packet, when a failure has occurred in both a predetermined working transport entity and protection transport entity, i.e., when a failure has occurred in at least two transport entities, a protection switching process (PSP) is used for performing appropriate linear protection switching using an added replacing transport entity or protection transport entity, and the PSP manages information about a transport entity and a multi-domain network and performs protection switching.

For effective linear protection switching, as shown in FIG. 1, an interworking protection switching apparatus according to an exemplary embodiment of the present invention may perform two step interworking protection switching using two protection switching processors 10 and 20.

The first protection switching processor 10 operates the working transport entity WP1 and the protection transport entity PP1 and is connected to the second protection switching processor 20 through a virtual working transport entity WP2. The second protection switching processor 20 operates the working transport entity WP2 and an additional protection transport entity PP2.

The first and second protection switching processors 10 and 20 perform information management and transport entity switching and control including failure information of a corresponding working transport entity and protection transport entity, and determine transmission/reception and switching of traffic that is carried to the transport entities. The first and second protection switching processors 10 and 20 function as bridges/selectors.

In failure information that is used for a protection switching, a failure state of the virtual working transport entity WP2 that connects the first and second protection switching processors 10 and 20 depends on the working transport entity WP1 and the protection transport entity PP1 and may be operated as in Table 1.

TABLE 1

| Status of virtual | | |
|---|---|---|
| (working) transport | Working transport | Protection transport |
| entity (WP2) | entity (WP1) | entity (PP1) |
| Normal (NR) | Normal (NR) | Normal (NR) |
| Normal (NR) | Normal (NR) | Failure (SF) |
| Normal (NR) | Failure (SF) | Normal (NR) |
| Failure (SF) | Failure (SF) | Failure (SF) |

In Table 1, normal represents a no request (NR) state in which a request such as any failure or a switching demand does not exist, and a failure represents a signal fail (SF) state in which a transport entity cannot be used due to damage.

In Table 1, for two step interworking protection switching, the working transport entity WP2 is a virtual transport entity, and only when a failure occurs in both the working transport entity WP1 and the protection transport entity PP1, it is recognized that the WP2 is a failure. Here, the first protection switching processor 10 that controls the working transport entity WP1 and the protection transport entity PP1 may be referred to as a “one stage protection switching processor”, and the second protection switching processor 20 that manages the working transport entity WP2 and the protection transport entity PP2 may be referred to as a “two stage protection switching processor”.

An additional protection transport entity is a replacing transport entity or protection transport entity that is added for protecting traffic when at least two transport entity failures occur. A protection switching processor within a node including a first protection switching processor or a second protection switching processor according to an exemplary embodiment of the present invention may be referred to as an interworking protection switching processor.

An automatic protection switching (APS) (or a protection state coordination (PSC) message) message for switching state management and transport entity protection switching is operated in both the protection transport entities PP1 and PP2. The APS message that is carried through the protection transport entity PP1 includes information about the working transport entity WP1 and the protection transport entity PP2 to protect the working transport entity WP1 and the protection transport entity PP1. The APS message that is carried through the PP2 includes information about the WP2 and the PP2 to enable interworking protection switching to be performed.

Additionally, when a plurality of protection transport entities PPn are necessary due to extension of a protected domain, i.e., when n-to-1 (where n represents the number of protection transport entities and 1 represents the number of working transport entities) protection switching is necessary, the protected domain may be extended with an n-step interworking protection switching processing method. That is, while adding a protection switching processor that controls an increased protection transport entity, by connecting protection switching processors through a virtual working transport entity, multi-step protection switching of FIG. 1 may be performed.

Further, for effective linear protection switching, as shown in FIG. 2, an interworking protection switching apparatus according to an exemplary embodiment of the present invention can perform one step interworking protection switching using a protection switching processor 30.

As shown in FIG. 2, an interworking protection switching processor 30 controls the working transport entity WP1 and the protection transport entities PP1 and PP2, determines transmission/reception and switching of traffic that is carried to the transport entities, and enables interworking protection switching to be performed.

An interworking protection switching processor that is formed with an protection switching processor manages transport entity state information and performs transport entity switching and control of the working transport entity WP1, the protection transport entity PP1, and the protection transport entity PP2, which are three logical transport entities. Until a failure occurs in both the working transport entity WP1 and the protection transport entity PP1, the protection transport entity PP2, which is an added replacing transport entity, does not participate in restoration of traffic protection. That is, when a failure is detected in two managed transport entities, the traffic is transmitted/received through an additional protection transport entity. A method of protecting and restoring using the protection transport entity PP2 in one step interworking protection switching is the same as a combination of a one stage protection switching processing function and a two stage protection switching processing function in a two step interworking protection switching of FIG. 1. Here, information that is carried through the protection transport entity PP1 or PP2 may include each of information about the working transport entity WP1 and the protection transport entity PP2 and information about the working transport entity WP2 and the protection transport entity PP2 or may include entire information about three transmitting transport entities.

Additionally, when a plurality of protection transport entities PPn are necessary, i.e., when n-to-1 protection switching is necessary due to extension of a protected domain, the protected domain can be extended with an n-step interworking protection switching processing method. That is, one stage protection switching processor may manage n increased protection transport entities.

In this way, an interworking protection switching apparatus according to an exemplary embodiment of the present invention is formed to include a one stage protection switching processor and a two stage protection switching processor in a node, as shown in FIG. 1 to perform two step interworking protection switching processing, or is formed as a one protection switching processor to perform one step interworking protection switching processing, as shown in FIG. 2.

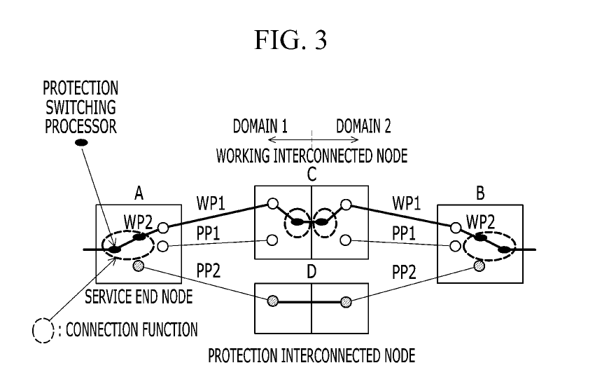

FIGS. 3 to 8 are diagrams illustrating a structure for protection switching in a multi-domain network based on an interworking protection switching apparatus according to an exemplary embodiment of the present invention.

A protection switching architecture of a protected multi-domain network may be modeled as shown in FIGS. 3 to 8. In each drawing, a connection function represents logical inclusion of a one step interworking protection switching processing method and a two step interworking protection switching processing method.

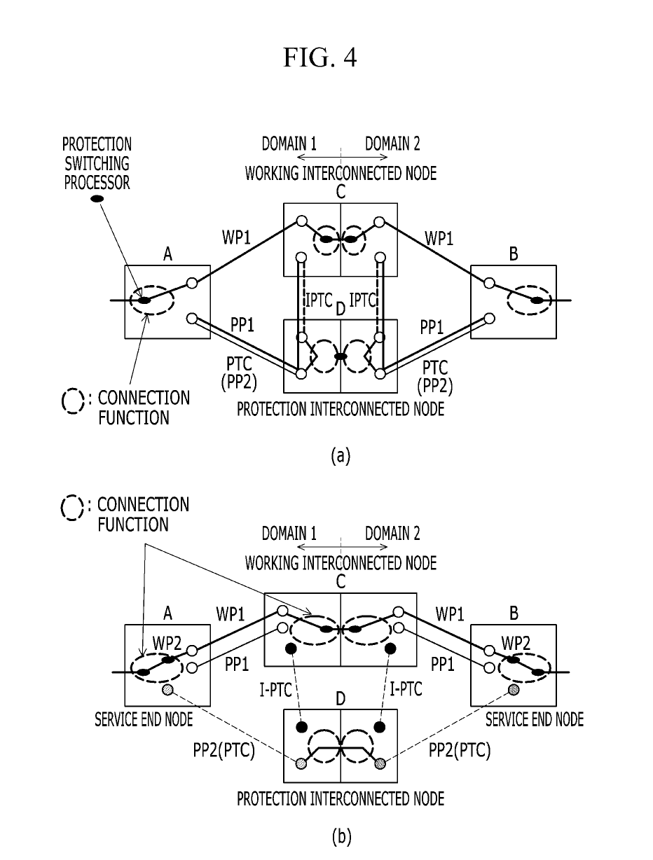

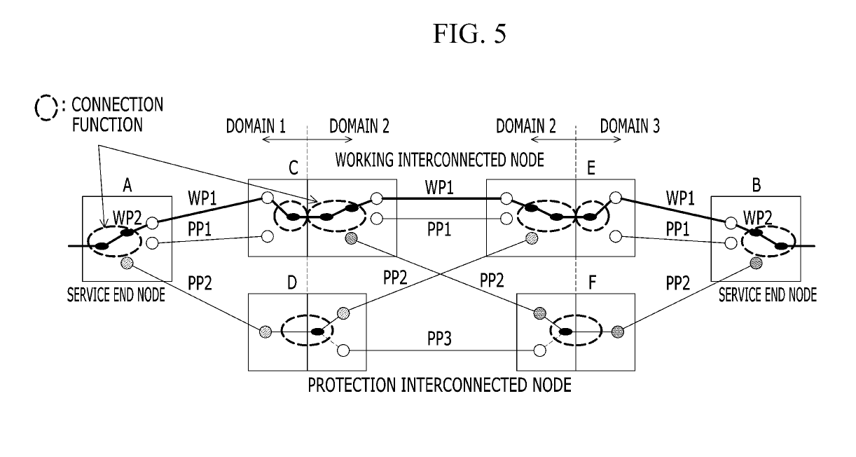

FIGS. 3 and 4 illustrate a case in which the number of protected domains is 2, and FIGS. 5 to 7 illustrate a case in which the number of protected domains is 3 or more. When the number of protected domains is 4, in FIGS. 5 to 8, while a protection switching configuration having a form of the domain 2 is added to a domain 3, in a domain 4, a protection switching configuration having a form of the domain 3 may be formed. When a domain to additionally protect is extended, an intermediate domain may be continuously extended in this way (to form a protection switching configuration of the domain 3 for a final domain while adding a protection switching configuration of a domain 2).

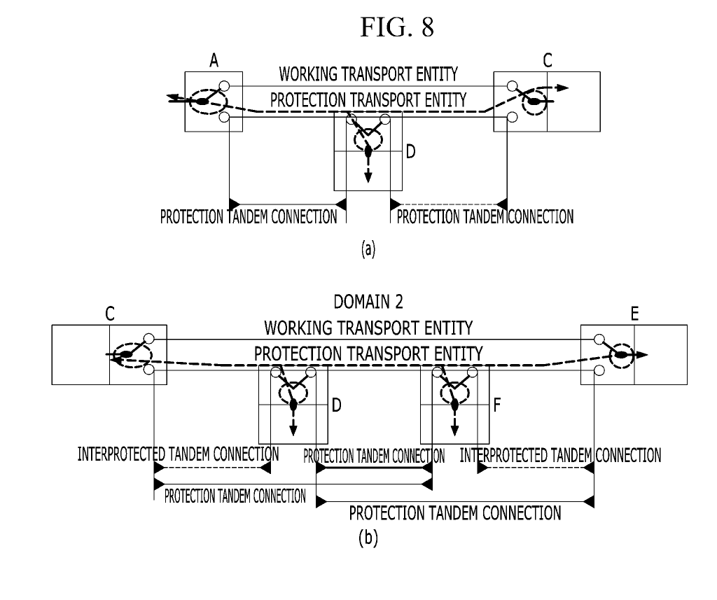

FIG. 8 illustrates a logical transport entity segment that manages to monitor each transport entity within a domain so as to protect each transport entity in domains. As physical transport entities corresponding to the number of logical transport entities exist, each logical transport entity may use a physical transport entity, and several logical transport entities may be included within a physical transport entity.

As shown in FIGS. 3 to 8, a node A and a node B are service end nodes of multiple protected domains. When a protected domain for a service (this service may be started from a protection switching processor of one end point and be provided to another protection switching processor of another end point) exists in a form of an end-to-end protection across multiple cascaded protected segment/domains, the nodes A and B are nodes having a selector/bridge, i.e., a protection switching processor in which transport entities acrossing the multiple network segment/domain are ended.

A node C and a node E are interconnected nodes and may be a working interconnected node and a protection interconnected node, respectively, and the working interconnected node is a node having a working transport entity (or a working path) within a protected domain.

The interconnected node may include one or two interworking protection switching processors (including a one stage or two stage protection switching processor), and may include an interworking protection switching processor on a corresponding domain basis and may be an interworking protection switching processor that manages maximum six transport entities. A protection switching processor of the interconnected node may be referred to as an interworking protection switching processor. The interconnected node may be formed with two physical nodes to perform protection switching for each of two connected domains, respectively and to transmit/receive traffic by using an additional physical entity that connects the physical nodes. Also, the interconnected node may be formed with one physical node in which a protection switching processor is logically divided to transmit/receive traffic through an additional physical entity.

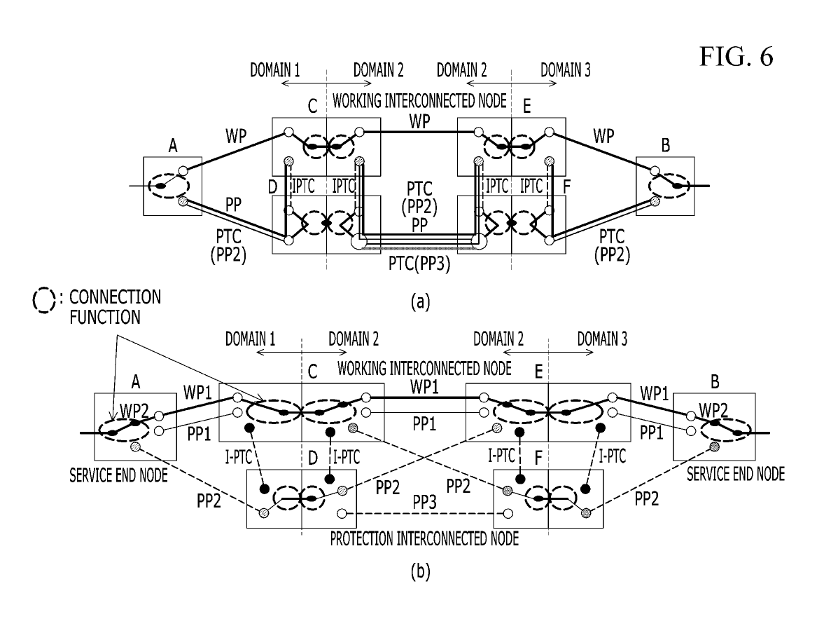

When a protection switching processor is operated to restore a transport entity without an additional protection transport entity PP2 due to one failure or less like a protection switching processor of a domain 1 (the domain 3 in the node E) in the node C in FIGS. 3 and 4 and the node C in FIGS. 5 and 6, the additional protection transport entity PP2 is maintained in an NR state.

Alternatively, in the node C of FIGS. 3 and 4 and the node C of FIGS. 5 and 6, like a protection switching processor of the domain 1 (the domain 3 in the node E), when participation of an additional protection transport entity is unnecessary due to one failure or less, by managing only two transport entities, a protection switching processor according to an existing communication specification may be used without extension. However, an additional message (APS or PSC message) for interworking protection switching should be able to be sent.

A node D and a node F are protection interconnected nodes, and are nodes that do not have a working transport entity within a protected domain.

In order to support interworking of a protection switching rule for traffic protection between two domains, the interconnected nodes transfer a protection switching message and traffic between two domains and nodes within domains with an appropriate transport entity as needed.

The protection interconnected node may include an interworking protection switching processor or may be operated without a protection switching processor. When the control of switching and transmission/reception of traffic that is carried to the domain 1 (domain 3 in the node F) in the node D of FIGS. 5 to 8 and domains of the node D of FIGS. 3 and 4 is unnecessary, the protection interconnected node may perform only a function of changing and transferring a protection switching message (an APS message or a PSC message) and traffic between domains and nodes within domains to be appropriate to an adjacent node and domain.

In FIGS. 5 to 8, when the node D (or the node F) includes an interworking protection switching processor of the domain 2, the interworking protection switching processor performs processing and controlling a protection switching message of the protection transport entity, and determines transmission/reception and protection switching of traffic that is carried to protection transport entities. The interworking protection switching processor may uses an additional protection transport entity PP2 as a basic active transport entity according to occurrence of at least two failures, and in a multi-domain network, when traffic protection is necessary, the interworking protection switching processor may transmit/receive traffic to and from another protection transport entity PP3.

FIGS. 4 and 6 illustrate a logical linear protection switching processing of a protected domain for including a ring topology configuration and a linear mesh topology configuration that the interworking protection switching processor manages in a multi-domain network.

In the linear mesh topology configuration, the number of logical protection transport entities that transmit/receive traffic and the number of managing transport entities are the same, and when corresponding the ring topology configuration to a linear protection switching rule, tandem connections (e.g., PP2, PP3, I-PTC) are formed by dividing a monitoring segment of one logical protection transport entity (e.g., protection transport entity PP1) to add several logical protection transport entities.

In the ring topology configuration, the number of transport entities, i.e., the number of each of a working transport entity and a protection transport entity in which actual data are transmitted/received is one in each domain of each node, and one working transport entity and one protection transport entity are formed like a ring.

Because a segment managed within a transport entity and an output to be transferred within a traffic node are different, tandem connections are used as a virtual transport entity to monitor a segment failure state and to carry traffic with an appropriate output in an automatic protection switching (APS) rule by an interworking protection switching processor. When the interworking protection switching processor monitors a transport entity state of each tandem connection and selects one of tandem connections based on the interworking APS rule, actual traffic is transferred to the appropriate protection transport entity (e.g., the protection transport entity PP1). That is, in the interworking protection switching processor, even if a change of traffic transmission/reception occurs between the protection transport entities PP1, PP2, and PP3, transmission/reception of actual data traffic of one protection transport entity is not changed, and actual switching occurs by only a selection change of traffic transmission/reception between the working transport entity and the protection transport entity.

When a management domain for linear protection switching is formed with a ring topology configuration, an interworking protection tandem connection (I-PTC) represents a tandem connection or a transport entity (or path) between interconnected nodes. The I-PTC may be used as a transfer transport entity of a message like an APS necessary for an interworking protection switching rule. As shown in FIGS. 4 and 6, by adding an I-PTC connection configuration in a linear mesh topology configuration, the I-PTC connection configuration may be used for carrying a protection switching message in one direction failure processing. The connection may exist in each management domain according to necessity of an interconnected node, and when an interconnected node is unnecessary, the connection may not exist.

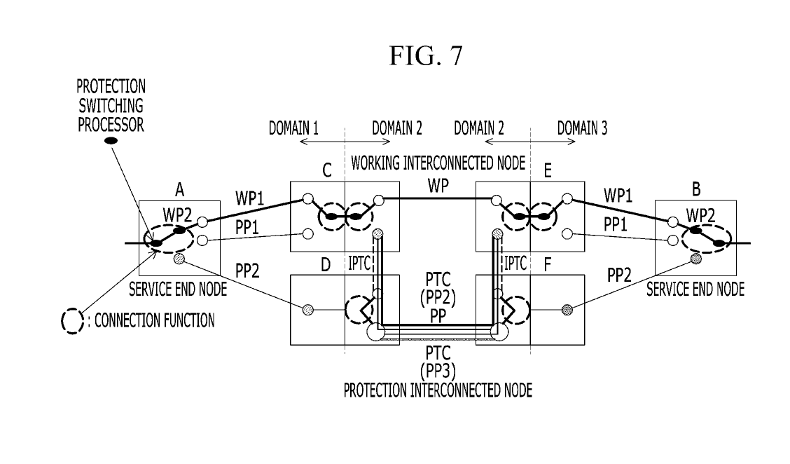

In a multi-domain network according to an exemplary embodiment of the present invention, a data transfer method of each domain (e.g., circuit switching of optical transport network (OTN), switching of an Ethernet switch, and label switching of multi-protocol label switching (MPLS)) may be different, and a method of operating the interworking protection switching processor may use a ring topology configuration or a linear mesh topology configuration according to transmission characteristics, or may mix and use the configurations. As shown in FIG. 7, an interworking protection switching processor existing on a domain basis of each node in each domain is set with an appropriate configuration method (e.g., a ring topology configuration or a linear mesh topology configuration) and performs protection switching.

In the ring topology configuration, as shown in FIG. 8, in an NR state, while performing traffic transfer between a service end node and an working interconnected node (or between working interconnected nodes), in the protection interconnected node (node D and node E), when it is recognized that a failure has occurred in both a working transport entity WP1 and a protection transport entity PP1, traffic should be transferred through an additional protection transport entity PP2 (including a PP3), which is a tandem connection. Therefore, only when both the working transport entity WP1 and the protection transport entity PP1 are not used, in order to protect data traffic, traffic may be transmitted to a protection transport entity between adjacent domains.

Hereinafter, in a multi-domain network having the above structure, when a failure has occurred, an interworking protection switching method that performs protection switching according to an exemplary embodiment of the present invention will be described.

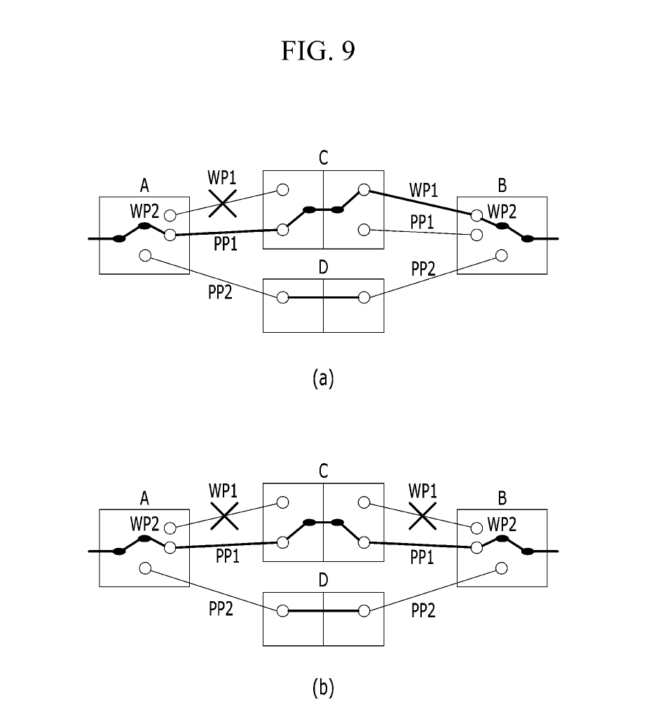

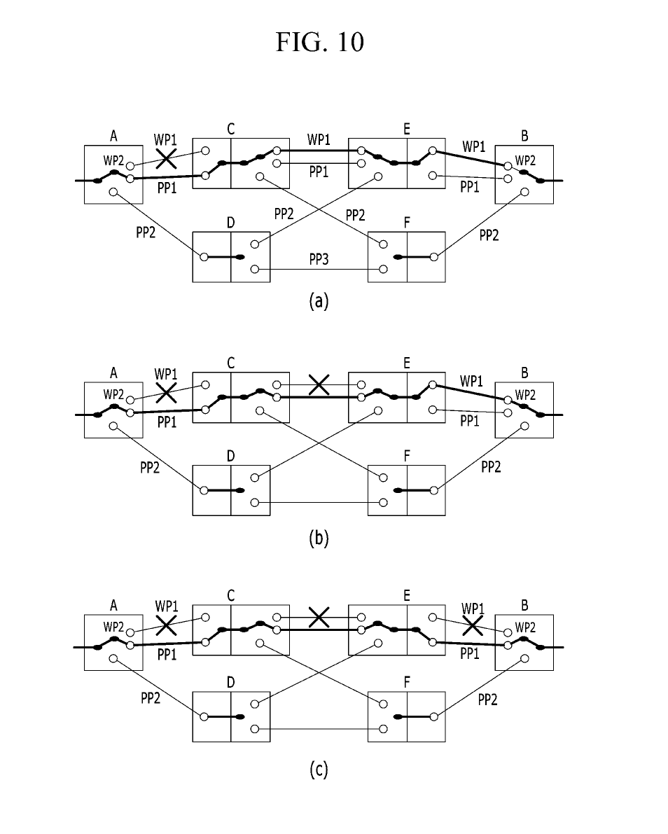

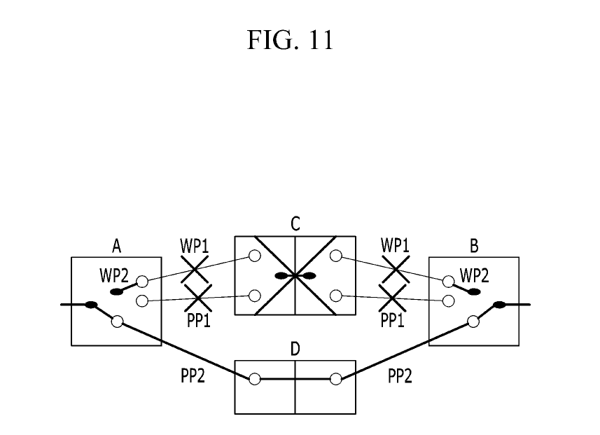

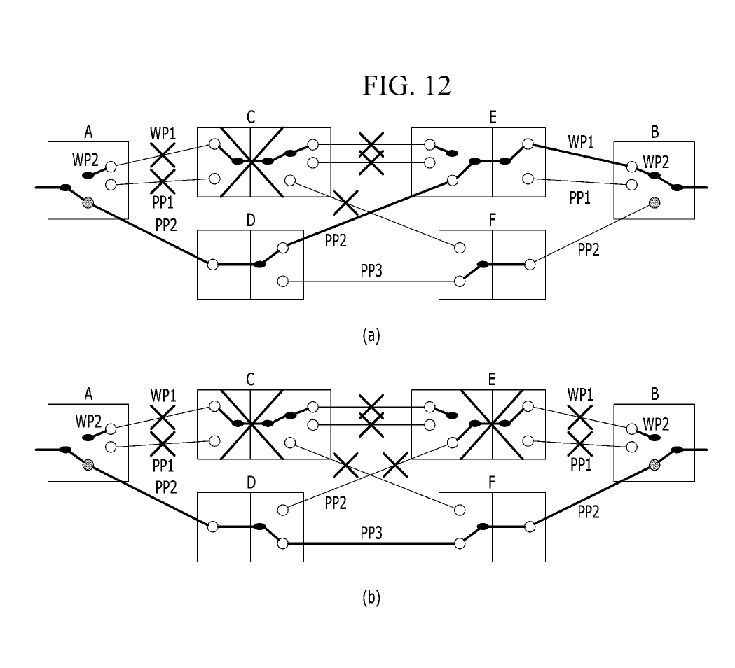

FIGS. 9 to 12 are diagrams illustrating an example of a protection switching processing when a failure has occurred in a multi-domain network according to an exemplary embodiment of the present invention. Particularly, FIGS. 9 and 10 illustrate a protection switching processing when a failure has occurred in a working transport entity WP1 in each domain, and FIGS. 11 and 12 are diagrams illustrating protection switching processing when a failure has occurred in a working interconnected node in each domain.

When a failure has occurred in the working transport entity WP1 in each domain, a failure may be restored by one stage protection switching processor, as shown in FIGS. 9 and 10.

Specifically, when transmitting/receiving traffic between a node A and a node B, if a failure occurs in the working transport entity WP1 between a working interconnected node C and the node A, as shown in (a) of FIG. 9 and (a) of FIG. 10, if a failure occurs in the working transport entity WP1 between the working interconnected node C and the node A and the working transport entity WP1 between the working interconnected node C and the node B, as shown in (b) of FIG. 9 and (c) of FIG. 10, or if a failure occurs in the working transport entity WP1 between the working interconnected nodes (node C and node E), as shown in (b) and (c) of FIG. 10, a one stage protection switching processor of each node performs switching to the protection transport entity PP1 and thus traffic from the node A is transferred to the node B via the working interconnected node C (or the node E) through the protection transport entity PP1.

Even if a failure occurs in the protection transport entity PP1 in each domain, a failure can be restored by a one stage protection switching processor. Except in case in which a failure occurs in both the working transport entity WP1 and the protection transport entity PP1 in each domain, a failure can be restored by a one stage protection switching processor.

As shown in FIGS. 11 and 12, when at least two failures have occurred in each domain or when at least two failures have occurred due to a node failure, for example, when a failure has occurred in a working interconnected node (the node C or the node E), a failure occurs in both the working transport entity WP1 and the protection transport entity PP1 in each domain and thus a failure can be restored by a two stage protection switching processor. Each node within the domain enables traffic transmission/reception between the node A and the node B to be performed through a protection interconnected node (node D) by switching traffic transmission/reception to the protection transport entity PP2 by the two stage protection switching processor, as shown in FIG. 11.

Further, when a failure has occurred in one node (e.g., a node C) of two interconnected nodes, as each node within the domain switches traffic transmission/reception to the protection transport entity PP2 by the two stage protection switching processor, as shown in (a) of FIG. 12, traffic is transmitted/received between the node A and the node B through the protection interconnected node D and the interconnected node E in which a failure does not occur.

Further, as a failure has occurred in both of two interconnected nodes (the node C and the node E), when a failure occurs in the protection transport entity PP2 (the domain 2) of the protection interconnected node, as each node within the domain switches traffic transmission/reception to the protection transport entity PP2 by the two stage protection switching processor of the node A, as shown in (b) of FIG. 12, and as a protection switching processor of the protection interconnected node D switches traffic transmission/reception to the protection transport entity PP3, traffic is transmitted/received between the node A and the node B through the protection transport entity PP3 between the protection interconnected node D and the protection interconnected node F.

In this way, even if a failure occurs in both the working transport entity WP1 and the protection transport entity PP1 in each domain, a failure can be restored by a two stage protection switching processor.

When at least two failures have occurred, as described above even in each node having a one stage interworking protection switching processor, each node within the domain switches traffic transmission/reception to the protection transport entity PP2 and switches traffic transmission/reception to another protection transport entity PP3 as needed.

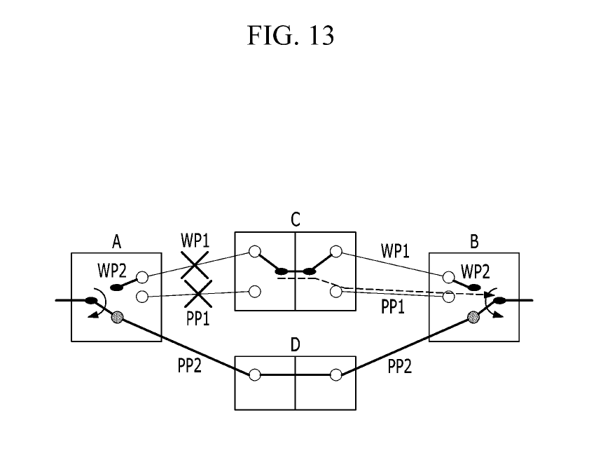

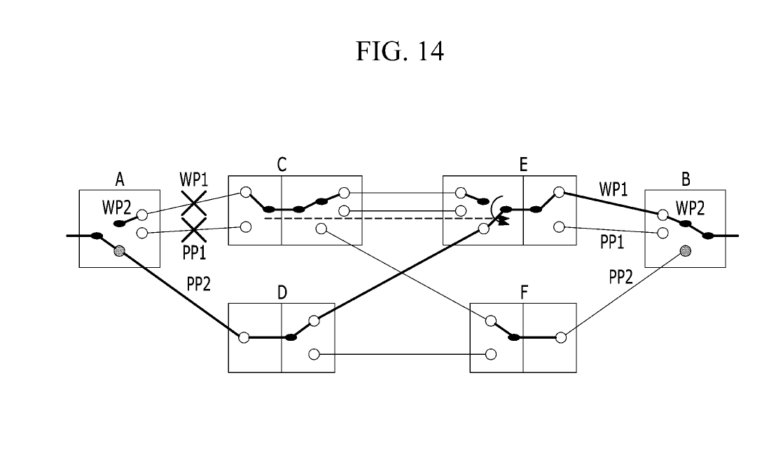

FIGS. 13 to 16 are diagrams illustrating another example of a protection switching processing when a failure has occurred in a multi-domain network according to an exemplary embodiment of the present invention.

As shown in FIGS. 13 and 14, when at least two failures have occurred in a domain (e.g., a domain 1) that is managed in a service end node (e.g., a node A) and an working interconnected node (e.g., a node C), if both of the connected working transport entity WP1 and protection transport entity PP1 are in a failure state, an interworking protection switching processor of the working interconnected node C may notify a node B (a node E in FIG. 14) corresponding to an adjacent domain (e.g., a domain 2) that a failure has occurred. In this case, the interworking protection switching processor of the working interconnected node C transmits a protection switching message, i.e., an APS or PSC message notifying that a failure has occurred through the protection transport entity PP1. Accordingly, the node B (node E in FIG. 14) corresponding to the adjacent domain (e.g., the domain 2) recognizes that a failure has occurred, performs switching to the protection transport entity PP2, and thus protects traffic.

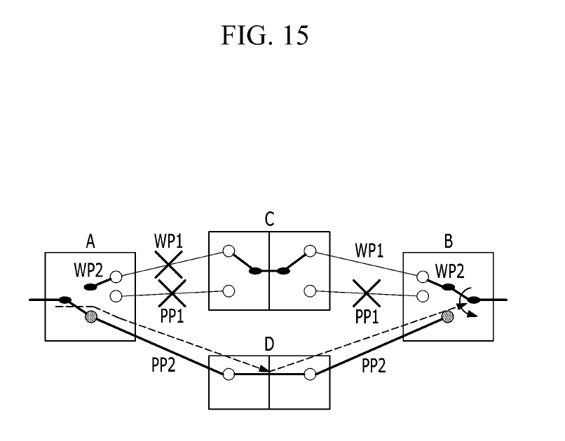

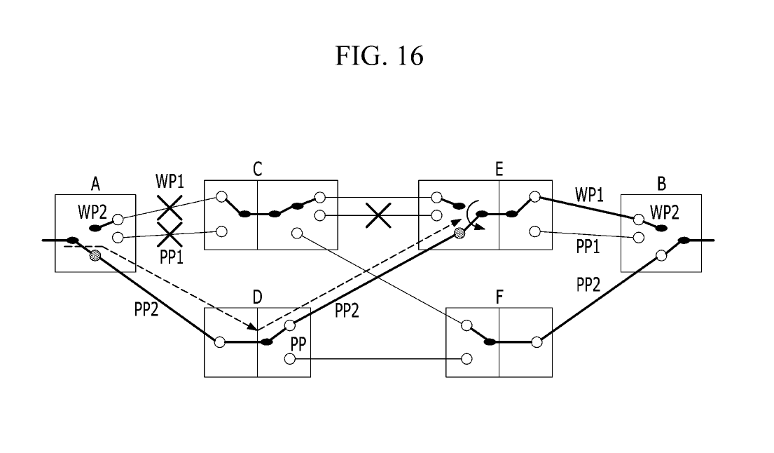

However, as shown in FIGS. 13 and 14, in a state in which a failure has occurred, as shown in FIGS. 15 and 16, when a failure has occurred even in the protection transport entity PP1 of the adjacent domain (e.g., the domain 2), an APS or PSC message notifying that a failure has occurred may not be transferred between the working interconnected nodes (the node C and the node Bin FIG. 15 and the node C and the node E in FIG. 16)

In this case, when at least two failures have occurred, a node, i.e., the node A that recognizes that a failure has occurred in both the working transport entity WP1 and the protection transport entity PP1 and that performs switching, notifies the protection interconnected node (node D) of this fact through the protection transport entity PP2, as shown in FIGS. 15 and 16. The protection interconnected node (node D), having received notification that the failure has occurred through an APS or PSC message processes the received APS or PSC message to an APS or PSC message appropriate to the adjacent domain (e.g., the domain 2), and transfers the processed APS or PSC message to an adjacent service end node (node B in FIG. 15) or an adjacent working interconnected node (node E in FIG. 16) through the protection transport entity PP2 (the domain 2). Accordingly, the interworking protection switching processor of the adjacent service end node (node B in FIG. 15) or the adjacent working interconnected node (node E in FIG. 16) recognizes that a failure has occurred through the received APS or PSC message, performs switching SW2 to the protection transport entity PP2, and thus protects traffic.

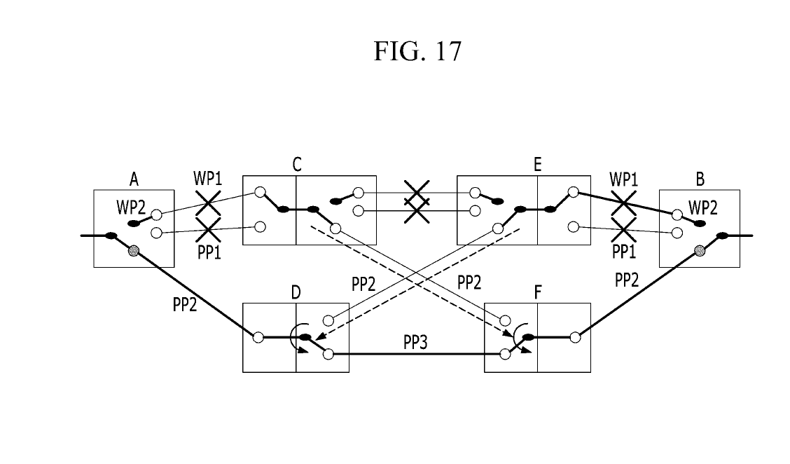

FIGS. 17 to 19 are diagrams illustrating another example of a protection switching processing when a failure has occurred in a multi-domain network according to an exemplary embodiment of the present invention.

As shown in FIG. 17, in a state in which an working interconnected node (a node C and a node E) recognizes that failures have occurred in both a working transport entity WP1 and a protection transport entity PP1 of a domain (the domain 2) and performs switching, when a failure has occurred in both the working transport entity WP1 and the protection transport entity PP1 of an adjacent domain (a domain 1 in the node C, and a domain 3 in the node E) that the working interconnected node manages, the working interconnected node (the node C and the node E) notifies the protection interconnected node (node F and node D) of this fact through the protection transport entity PP2 of the domain 2. That is, the node C notifies the protection interconnected node F that a failure has occurred in both the working transport entity WP1 and the protection transport entity PP1 of the domain 2 through the protection transport entity PP2. The node E notifies the protection interconnected node D that a failure has occurred in both the working transport entity WP1 and the protection transport entity PP1 of the domain 2 through the protection transport entity PP2.

Accordingly, the protection interconnected node (node F and node D) performs switching to the protection transport entity PP3 for traffic protection.

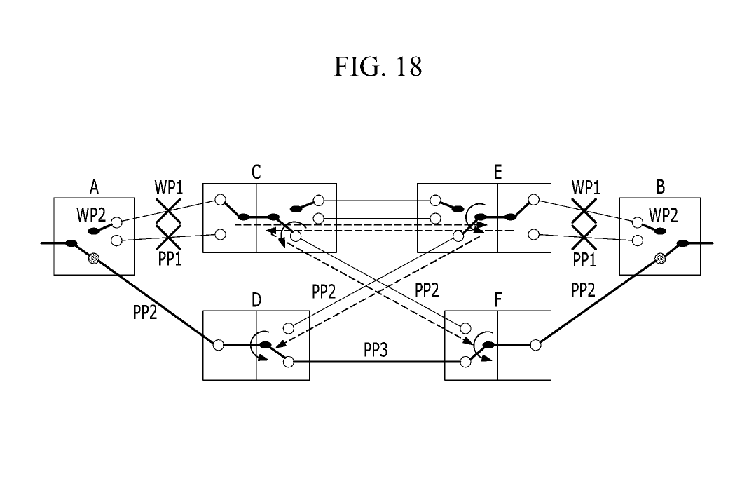

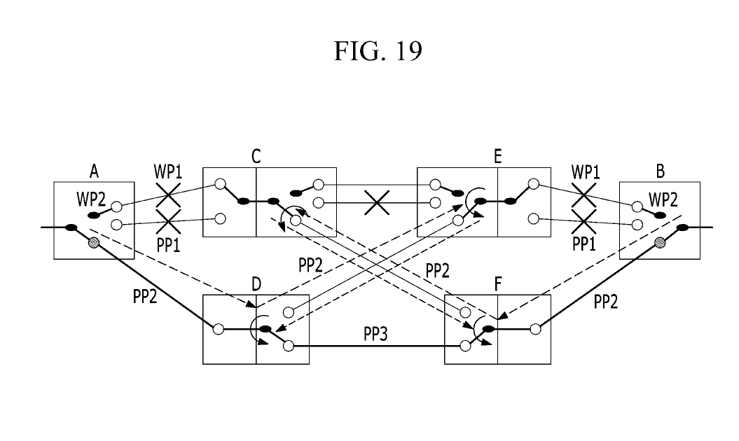

Further, as shown in FIGS. 18 and 19, the working interconnected node (the node C or node E) may receive an APS or PSC message notifying that a failure has occurred in both the working transport entity WP1 and the protection transport entity PP1 of an adjacent node to which the working interconnected node is not connected. That is, the node C receives an APS or PSC message notifying that a failure has occurred in both a working transport entity and a protection transport entity of the domain 3 from the node E through the protection transport entity PP1, and the node E receives an APS or PSC message notifying that a failure has occurred in both the working transport entity and the protection transport entity of the domain 1 from the node C through the protection transport entity PP1.

In this case, the working interconnected node (the node C and the node E) notifies the protection interconnected node (node F or node D) that the above failure has occurred through the protection transport entity PP2 of the domain 2. That is, the node C notifies the protection interconnected node F that a failure has occurred in both the working transport entity WP1 and the protection transport entity PP1 of the domain 3 through the protection transport entity PP2. The node E notifies the protection interconnected node D that a failure has occurred in both the working transport entity WP1 and the protection transport entity PP1 of the domain 1 through the protection transport entity PP2.

Accordingly, the protection interconnected node (node F and node D) performs switching to the protection transport entity PP3 for traffic protection.

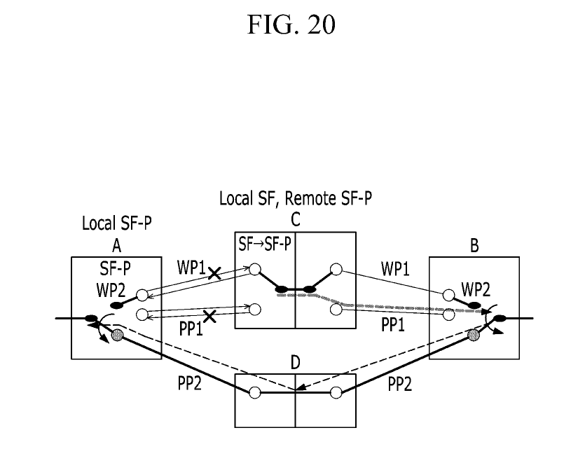

FIG. 20 is a diagram illustrating another example of a protection switching processing when a failure has occurred in a multi-domain network according to an exemplary embodiment of the present invention.

FIG. 20 illustrates a case in which a failure does not occur in a bi-direction but occurs in one direction in a transport entity.

When a local failure of a working transport entity and a remote failure of a protection transport entity (here, a remote failure represents a failure that is recognized through an APS or PSC message transmitted from a node of managing a protection transport entity in which a failure has occurred) are recognized, the interworking protection switching processor of the working interconnected node recognizes that a failure has occurred in both the working transport entity and the protection transport entity and operates. That is, as shown in FIG. 20, the working interconnected node C notifies the service end node B (or a related working interconnected node) of an APS or PSC message notifying that a failure has occurred through the protection transport entity PP1, and thus the service end node B (or a related working interconnected node) transfers a fact that a failure has occurred to a corresponding service end node A (or a related working interconnected node) through the protection transport entity PP2. Accordingly, the service end node A (or a related working interconnected node) that has not recognized the one direction failure even if the one direction failure occurs performs switching to the protection transport entity PP2 and transfers traffic.

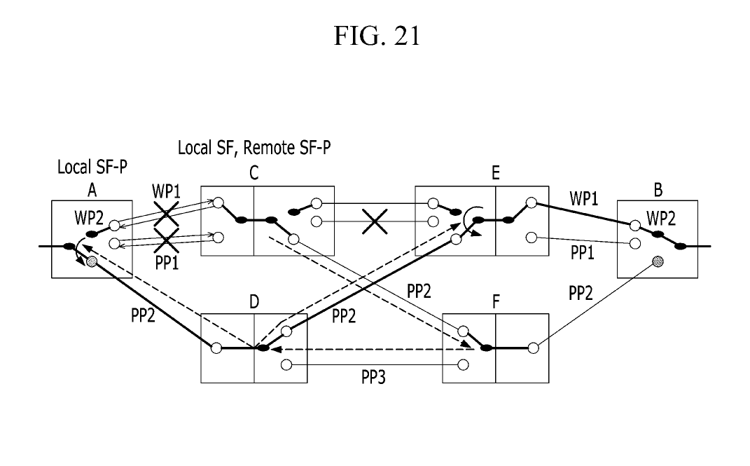

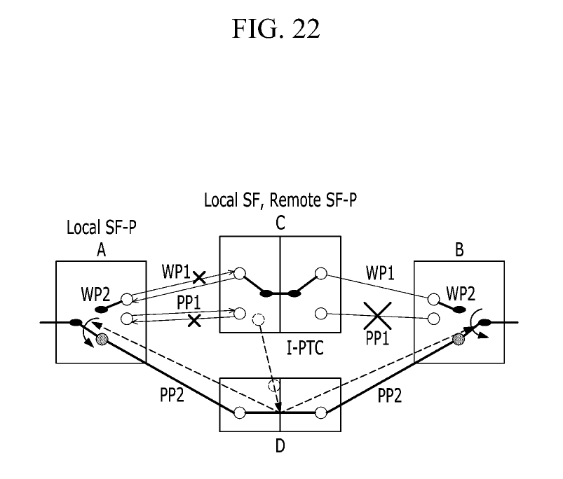

FIGS. 21 and 22 are diagrams illustrating another example of a protection switching processing when a failure has occurred in a multi-domain network according to an exemplary embodiment of the present invention. FIGS. 21 and 22 illustrate a case in which a failure does not occur in a bi-direction but occurs in one direction in a transport entity and that cannot transmit information representing that a failure has occurred due to damage in a protection transport entity PP1 of an adjacent domain.

Specifically, as a local failure of a working transport entity and a remote failure of a protection transport entity are recognized, in a state that recognizes that a failure has occurred in both the working transport entity and the protection transport entity, when damage has occurred in the protection transport entity PP1 of an adjacent domain, the interworking protection switching processor of the working interconnected node cannot transmit failure occurrence related information to a service end node (or a related working interconnected node). In order to solve such a case, the interworking protection switching processor sends an APS or PSC message notifying that a failure has occurred to the protection interconnected node through the protection transport entities PP2 and PP3, as shown in FIGS. 21 and 22.

The protection interconnected node, having received this information, notifies an APS or PSC message to a service end node (or a related working interconnected node) of a domain in which a failure has occurred and to a service end node (or a related working interconnected node) of an adjacent domain of an interconnected node that recognizes a simultaneous failure of the working transport entity WP1 and the protection transport entity PP1 and enables to perform traffic protection switching.

Specifically, in FIG. 21, the interworking protection switching processor of the node C transmits an APS or PSC message notifying the protection interconnected node E that a failure has occurred through the protection transport entity PP2, and the protection interconnected node E transmits the APS or PSC message to the protection interconnected node D that is related to the service end node A of a domain in which a failure has occurred. Thereafter, the protection interconnected node D notifies a fact that a failure has occurred to the service end node A of a domain in which a failure has occurred and the interconnected node E of an adjacent domain of the interconnected node C that recognizes a simultaneous failure of the working transport entity WP1 and the protection transport entity PP1 through the protection transport entity PP2. Accordingly, the service end node A performs switching to the protection transport entity PP2 and the interconnected node E performs switching to the protection transport entity PP2, and thus traffic from the service end node A is transferred to the service end node B through the protection interconnected node D and the interconnected node E.

Further, in FIG. 22, the interworking protection switching processor of the node C transmits an APS or PSC message notifying that a failure has occurred to the protection interconnected node D using an I-PTC, which is a additional protection transport entity formed between the working interconnected node and the protection interconnected node.

In this case, the protection interconnected node D transmits an APS or PSC message to the service end node A of a domain in which a failure has occurred and the service end node B of an adjacent domain of the interconnected node C that recognizes the simultaneous failure through the protection transport entity PP2. Thereafter, each of the service end nodes A and B, having recognized that a failure has occurred, performs switching to the protection transport entity PP2 and thus traffic from the service end node A is transferred to the service end node B through the protection interconnected node D.

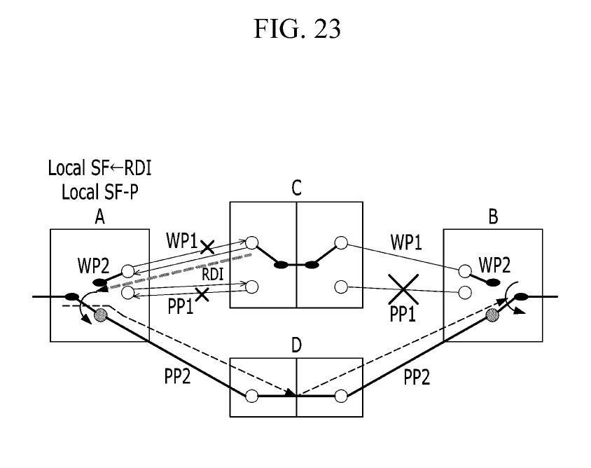

FIG. 23 is a diagram illustrating another example of a protection switching processing when a failure has occurred in a multi-domain network according to an exemplary embodiment of the present invention. FIG. 23 illustrates that a service end node (or a related working interconnected node) recognizes that a failure has occurred in both of two managed transport entities and performs protection switching using an additional operations, administration, and maintenance (OAM) message (or a remote defect indication (RDI) message) when a one direction failure is recognized in two managed transport entities WP1 and PP1 like a local failure of a working transport entity and a remote failure of a protection transport entity, as described above.

Specifically, as shown in FIG. 23, as a local failure of the working transport entity and a remote failure of the protection transport entity are recognized, in a state in which it is recognized that a failure has occurred in both a working transport entity and a protection transport entity, when damage has occurred in the protection transport entity PP1 of an adjacent domain, the interworking protection switching processor of the working interconnected node cannot transmit failure occurrence related information to a service end node (or a related working interconnected node). In this case, the working interconnected node C may notify that a failure has occurred by transmitting an RDI message to the service end node A of a domain in which a failure has occurred. Accordingly, the service end node A can protect traffic by performing switching to the protection transport entity PP2.

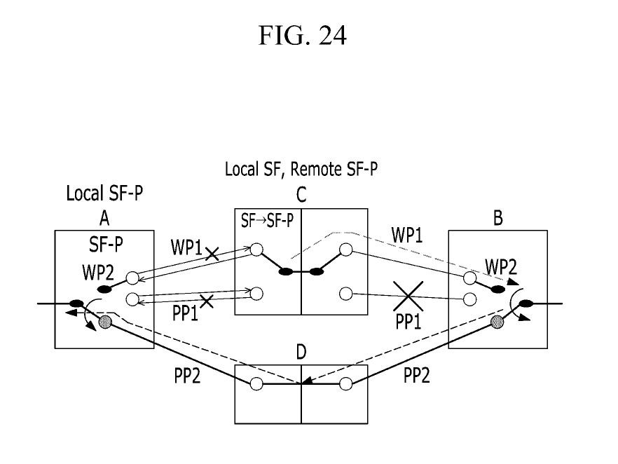

FIGS. 20 to 23 illustrate that each transport entity is a bidirectional transport entity for transmission and reception, and FIG. 24 illustrates a transport entity between a node A and a node C using two unidirectional transport entity lines so as to represent a unidirectional failure in a bidirectional transport entity.

FIG. 24 is a diagram illustrating another example of a protection switching processing when a failure has occurred in a multi-domain network according to an exemplary embodiment of the present invention. FIG. 24 illustrates preparation of a case that cannot notify a service end node (or a related working interconnected node) that a failure has occurred, as damage occurs in the protection transport entity PP1 of an adjacent domain, when a one direction failure is recognized in two managed transport entities WP1 and PP1 like a local failure of a working transport entity and a remote failure of a protection transport entity, as described above. Here, the interworking protection switching processor notifies a service end node (or a related working interconnected node) that a failure has occurred through an additional APS option (transmitting an APS or PSC message through the working transport entity WP1) through the working transport entity WP1 as well as the alive protection transport entity PP1.

In FIG. 24, although damage has occurred in the protection transport entity PP1 of an adjacent domain, the working interconnected node C transmits an APS or PSC message notifying that a failure has occurred to the service end node B through the working transport entity WP1 according to an APS option. Accordingly, the service end node B protects traffic by switching to the protection transport entity PP2.

The foregoing failure occurrence notification using an APS or PSC message may be transferred between each node though a logical information signal of a form other than an APS or PSC message.

According to an exemplary embodiment of the present invention, in a multi-domain network, even if a failure occurs in a connection node and a transport entity for transmitting/receiving a packet, appropriate linear protection switching can be performed.

In each domain, even when a failure occurs in both a working transport entity and a protection transport entity and even when at least one failure occurs in each domain as well as a single transport entity failure and a single node failure, traffic can be protected through an additional protection transport entity.

Further, when actually operating a network, by supporting node dualization in which many operators are required, reliability of the network can be enhanced.

The foregoing exemplary embodiment of the present invention may not only be embodied through an apparatus and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for protection switching in a multi-domain network or a multi-segment network in which at least one interconnected node is formed between nodes of a protected domain, the method comprising:
performing switching to an added replacing transport entity or protection transport entity, when at least two failures have occurred within a protection domain.

2. The method of claim 1, wherein the performing of switching comprises, when at least two failures have occurred, as a failure has occurred in both a working transport entity and a first protection transport entity of a node, performing, by a node having recognized the failures, switching to a corresponding second protection transport entity, and
the second protection transport entity comprises a transport entity connected to an interworking node that enables traffic between domains to be transmitted/received by avoiding an occurred failure.

3. The method of claim 2, wherein each node uses an interconnected node that performs traffic protection switching through a working transport entity and a first protection transport entity and another interconnected node that is used for transmitting and receiving traffic to and from an adjacent domain through a second protection transport entity for at least two failures.

4. The method of claim 3, wherein a service end node communicates with an working interconnected node corresponding to an adjacent node through a working transport entity and a first protection transport entity and communicates with a protection interconnected node corresponding to an adjacent node through a second protection transport entity,
the working interconnected node communicates with an end node or an working interconnected node corresponding to an adjacent node through a working transport entity and a first protection transport entity and communicates with a protection interconnected node or an end node corresponding to an adjacent node through a second protection transport entity, and
each interconnected node communicates with another protection interconnected node corresponding to an adjacent domain through a third protection transport entity.

5. The method of claim 3, wherein the performing of switching to a second protection transport entity comprises performing, by the node having recognized a failure, switching to a second protection transport entity that is connected to the protection interconnected node, when it is recognized that a failure has occurred in both a working transport entity and a first protection transport entity corresponding to the working interconnected node in which the failure has occurred.

6. The method of claim 4, wherein the node, having recognized a failure, in the multi-domain network, is at least one of two service end nodes and several interconnected nodes and other working interconnected nodes that is able to transmit/receive traffic to and from a corresponding adjacent domain by recognizing that a failure has occurred in two or more nodes in at least one domain.

7. The method of claim 3, wherein the performing of switching to a second protection transport entity comprises:
notifying, by the working interconnected node, a corresponding node in its domain or a node corresponding to an adjacent domain that a failure has occurred, when a failure has occurred in both the working transport entity and the first protection transport entity that are connected to a domain that is managed by the working interconnected node and the first service end node;
performing, by the node having received notification that the failures have occurred, switching to the second protection transport entity that is connected to the protection interconnected node; and
performing, by the first service end node, switching to the second protection transport entity that is connected to the protection interconnected node.

8. The method of claim 3, wherein the performing of switching to a second protection transport entity comprises:
when a failure has occurred in both the working transport entity and the first protection transport entity that are connected to a domain that is managed in the working interconnected node and the first service end node and when a failure has occurred in the first protection transport entity with a node of an adjacent domain corresponding to the working interconnected node,
performing, by the first service end node, switching to the second protection transport entity of a corresponding protection interconnected node;
transmitting, by the first service end node, a message notifying that the failure has occurred through the second protection transport entity of the protection interconnected node;
notifying, by the protection interconnected node having received the message, a node corresponding to an adjacent domain that the failure has occurred; and
performing, by the node having received notification that the failure has occurred, switching to the second protection transport entity that is connected to the protection interconnected node.

9. The method of claim 3, wherein the performing of switching to a second protection transport entity comprises:
when a failure has occurred in both a working transport entity and a first protection transport entity that are connected to a domain that is managed in a service end node and the working interconnected node and when a failure has occurred in a working transport entity and a first protection transport entity related to a node of an adjacent domain corresponding to the working interconnected node,
notifying, by the working interconnected node, that the failure has occurred through a second protection transport entity of a protection interconnected node corresponding to an adjacent domain;
performing, by the protection interconnected node having received notification that a failure has occurred, switching to a third protection transport entity that is connected to another protection interconnected node corresponding to an adjacent domain; and
performing, by each node, switching to a second protection transport entity of a corresponding protection interconnected node.

10. The method of claim 3, wherein the performing of switching to a second protection transport entity comprises:
when a failure has occurred in both a working transport entity and a first protection transport entity that are connected to a domain that is managed in a service end node and a working interconnected node
receiving, by the working interconnected node, notification that the failure has occurred through a second protection transport entity of another working interconnected node corresponding to an adjacent domain;
notifying, by the working interconnected node having received notification that the failure has occurred, that the failure has occurred through a second protection transport entity of a protection interconnected node corresponding to an adjacent domain;
switching, by the protection interconnected node having received notification that the failure has occurred, to a third protection transport entity that is connected to another protection interconnected node corresponding to an adjacent domain;
switching to a third protection transport entity that is connected to a protection interconnected node corresponding to an adjacent domain; and
switching, by each node, to a second protection transport entity of a corresponding protection interconnected node.

11. The method of claim 3, wherein the performing of switching to a second protection transport entity comprises:
when a failure has occurred in both a working transport entity and a first protection transport entity between the first service end node and the working interconnected node and when the occurred failure is a one direction failure,
notifying, by the working interconnected node, that the failure has occurred through a first protection transport entity of the second service end node or another working interconnected node of an adjacent domain;
performing, by the node having received notification that the failure has occurred, switching to a second protection transport entity of a corresponding protection interconnected node; and
performing, by the first service end node, switching to a second protection transport entity of a corresponding protection interconnected node.

12. The method of claim 3, wherein the performing of switching to a second protection transport entity comprises:
when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node,
notifying, by the working interconnected node, the protection interconnected node that the failure has occurred through a protection transport entity that is additionally formed between corresponding protection interconnected nodes;
notifying, by the protection interconnected node, to the first service end node and the second service end node that a failure has occurred through a second protection transport entity;
performing, by the first service end node, switching to a second protection transport entity of the protection interconnected node; and
performing, by the second service end node, switching to a second protection transport entity of the protection interconnected node.

13. The method of claim 12, wherein the additionally formed protection transport entity is a tandem connection.

14. The method of claim 3, wherein the performing of switching to a second protection transport entity comprises:
when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node,
notifying, by the working interconnected node, that the failure has occurred by transmitting an additional operations, administration, and maintenance (OAM) message to the first service end node; and
performing, by the first service end node, switching to a second protection transport entity of a corresponding protection interconnected node.

15. The method of claim 14, further comprising:
notifying, by the first service end node, that a failure has occurred through a second protection transport entity of the protection interconnected node;
notifying, by the protection interconnected node, the second service end node that a failure has occurred through the second protection transport entity; and
performing, by the second service end node, switching to the second protection transport entity of the protection interconnected node.

16. The interworking PSP of claim 3, wherein the performing of switching to a second protection transport entity comprises
when a failure has occurred in both a working transport entity and a first protection transport entity between the first service end node and the working interconnected node, when the occurred failure is a one direction failure, and when a failure has occurred in a first protection transport entity with a node corresponding to an adjacent domain of the working interconnected node,
notifying, by the working interconnected node, that a failure has occurred by transmitting an automatic protection switching (APS) or protection state coordination (PSC) message to a node corresponding to the adjacent domain through a working transport entity according to an additional APS option.

17. An interworking protection switching apparatus for performing protection switching in a multi-domain network or a multi-segment network in which at least one interconnected node is formed between nodes of a protected domain, the interworking protection switching apparatus comprising:
an interworking protection switching processor for performing switching a transport entity in which there is no failure among protection transport entities when a plurality of failures have occurred within a protection domain.

18. The interworking protection switching apparatus of claim 17, wherein the interworking protection switching processor comprises
a one stage protection switching processor that performs switching to a protection transport entity, when a failure has occurred within a protection domain; and
a two stage protection switching processor that performs switching to an added replacing transport entity or protection transport entity, when at least two failures have occurred within a protection domain.

19. The interworking protection switching apparatus of claim 18, wherein the two stage protection switching processor, when at least two failures have occurred, as a failure has occurred in both a working transport entity and a first protection transport entity of a node, performs switching to a corresponding second protection transport entity, and the second protection transport entity comprises a transport entity connected to an interworking node that enables traffic between domains to be transmitted/received by avoiding an occurred failure.

20. The interworking protection switching apparatus of claim 18, wherein the each node communicates with an working interconnected node through a working transport entity and a first protection transport entity and communicates with a protection interconnected node through a second protection transport entity,
each working interconnected node communicates with an working interconnected node corresponding to an adjacent domain through a working transport entity and a first protection transport entity and communicates with a protection interconnected node corresponding to an adjacent domain through a second protection transport entity, and
each protection interconnected node communicates with another protection interconnected node corresponding to an adjacent domain through a third protection transport entity.
